(19) United States
(12) Patent Application Publication
(10) Pub. No.: US 2011/0096699 A1
(43) Pub. Date: Apr. 28, 2011

(54) MEDIA PIPELINE FOR A CONFERENCING SESSION

(76) Inventors: Srinivasa SAKHAMURI, Fort Collins, CO (US); Byron A. Alcorn, Fort Collins, CO (US)

(21) Appl. No.: 12/606,894

(22) Filed: Oct. 27, 2009

(51) Int. Cl. H04L 12/16

(52) U.S. Cl. 370/260

(57) ABSTRACT

In at least some embodiments, a computer system includes a processor and a network interface coupled to the processor. The computer system also includes a system memory coupled to the processor. The system memory stores a communication application having a media pipeline module. The media pipeline module, when executed, provides a media pipeline for a conferencing session of the communication application. The media pipeline module enables dynamic changes to participants during a conferencing session without restarting the media pipeline.

### CROSS-REFERENCE TO RELATED APPLICATIONS

The present application may be related to each of the following applications: U.S. application Ser. No. 12/551,273, filed Aug. 31, 2009, and entitled “COMMUNICATION APPLICATION”; U.S. application Ser. No. ______ (Atty. Docket No. 2774-14800), filed ______, and entitled “COMMUNICATION APPLICATION WITH STEADY-STATE CONFERENCING”; and U.S. application Ser. No. ______ (Atty. Docket No. 2774-14700), filed ______, and entitled “ACOUSTIC ECHO CANCELLATION (AEC) WITH CONFERENCING ENVIRONMENT TEMPLATES (CETs)”, all hereby incorporated herein by reference in their entirety.

### BACKGROUND

Remote conferencing sessions between different computing devices are dependent on establishing a media pipeline (e.g., an audio/video pipeline) between at least two communication endpoints. Unfortunately, many media pipelines are unable to handle changes during a conferencing session, resulting in interruptions to the conferencing experience. Adding/removing participants and mute/unmute requests are examples of media pipeline changes that may interrupt a conferencing experience.

### BRIEF DESCRIPTION OF THE DRAWINGS

For a detailed description of exemplary embodiments of the invention, reference will now be made to the accompanying drawings in which:

FIG. 1 illustrates a system in accordance with embodiments of the disclosure;

FIG. 2 illustrates various software components of a communication application in accordance with an embodiment of the disclosure;

FIGS. 3A and 3B illustrate operation of an audio premix component in accordance with an embodiment of the disclosure;

FIGS. 4A and 4B illustrate audio/video transmission in accordance with an embodiment of the disclosure;

FIGS. 5A and 5B illustrate audio/video reception in accordance with an embodiment of the disclosure;

FIG. 6 illustrates components of a media pipeline in accordance with am embodiment of the disclosure;

FIGS. 7A-7B illustrate configuration of a media pipeline based on Extensible Markup Language (XML) in accordance with an embodiment of the disclosure;

FIG. 8 illustrates a conferencing technique in accordance with an embodiment of the disclosure; and

FIG. 9 illustrates a method in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention are directed to techniques for remote conferencing via at least one intermediary network. In accordance with embodiments, a communication application provides a media pipeline for a conferencing session via the intermediary network. As used herein, “media pipeline” refers to software components that transform media from one form to another. For example, a media pipeline may compress and mix media to be transmitted, format media for transmission via a network, recover media received via a network, unmix received media, and de-compress received media. In accordance with embodiments, a media pipeline comprises software components implemented by a media transmitting device and a media receiving device.

The media pipeline supports various features such as participant control (e.g., adding or dropping participants from a conference), pre-conference negotiation of client parameters (e.g., codecs, client address, port information), media stream activity control (e.g., stopping a media stream to decrease system bandwidth consumption), and combining audio streams (e.g., to maintain synchronization and acoustic echo cancellation (AEC)). Further, in at least some embodiments, the media pipeline is configurable using Extensible Markup Language (XML).

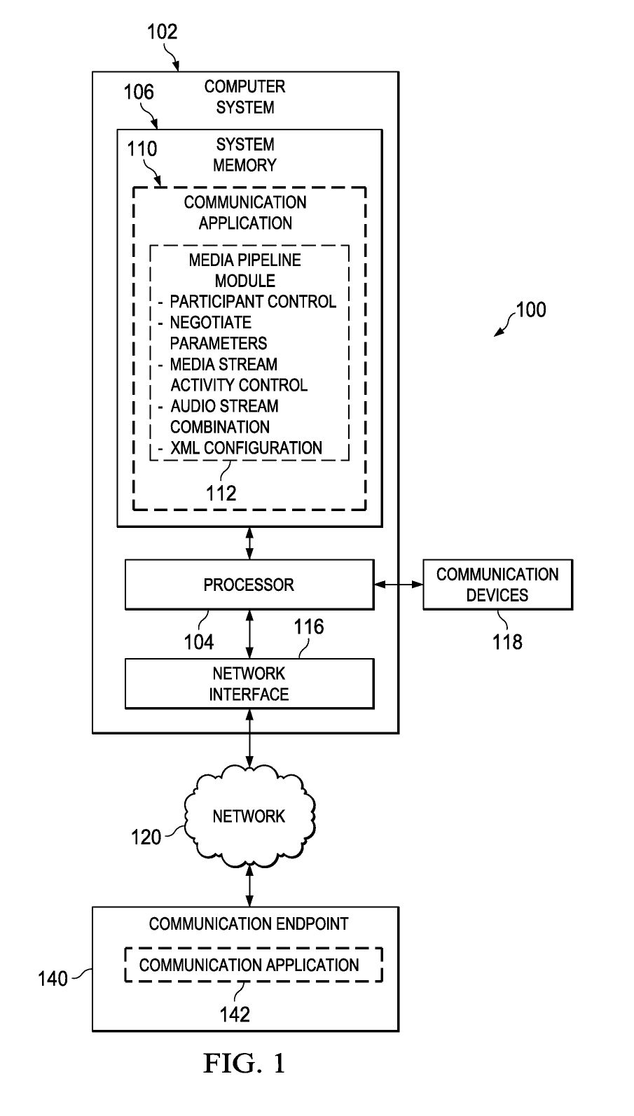

FIG. 1 illustrates a system 100 in accordance with embodiments of the disclosure. As shown in FIG. 1, the system 100 comprises a computer system 102 coupled to a communication endpoint 140 via a network 120. The computer system 102 is representative of a desktop computer, a laptop computer, a “netbook,” a smart phone, a personal digital assistant (PDA), or other electronic devices. Although only one communication endpoint 140 is shown, it should be understood that the computer system 102 may be coupled to a plurality of communication endpoints via the network 120. Further, it should be understood, that the computer system 102 is itself a communication endpoint. As used herein, a “communication endpoint” refers to an electronic device that is capable of running a communication application and supporting a remote conferencing session.

In accordance with embodiments, the computer system 102 and communication endpoints (e.g., the communication endpoint 140) employ respective communication applications 110 and 142 to facilitate efficient remote conferencing sessions. As shown, the communication application 110 comprises a media pipeline module 112. Although not required, the communication application 142 may comprise the same module(s) as the communication application 110. Various operations related to the media pipeline module 112 will later be described.

As shown in FIG. 1, the computer system 102 comprises a processor 104 coupled to a system memory 106 that stores the communication application 110. In accordance with embodiments, the processor 104 may correspond to at least one of a variety of semiconductor devices such as microprocessors, central processing units (CPUs), microcontrollers, main processing units (MPUs), digital signal processors (DSPs), advanced reduced instruction set computing (RISC) machines, ARM processors, application specific integrated circuits (ASICs), field programmable gate arrays (FPGAs) or other processing devices. In operation, the processor 104 performs a set of predetermined functions based on data/instructions stored in or accessible to the processor 104. In at least some embodiments, the processor 104 accesses the system memory 106 to obtain data/instructions for the predetermined operations. The system memory 106 is sometimes referred to as a computer-readable storage medium and may comprise volatile memory (e.g., Random Access Memory), non-volatile memory (e.g., a hard drive, a flash drive, an optical disk storage, etc.), or both.

To support a remote conferencing session, the computer system 102 comprises communication devices 118 coupled to the processor 104. The communication devices may be built-in devices and/or peripheral devices of the computer system 102. As an example, the communication devices 118 may correspond to various input devices and/or output devices such as a microphone, a video camera (e.g., a web-cam), speakers, a video monitor (e.g., a liquid crystal display), a keyboard, a keypad, a mouse, or other devices that provide a user interface for communications. Each communication endpoint (e.g., the communication endpoint 140) also may include such communication devices.

To enable remote conferencing sessions with communication endpoints coupled to the network 120, the computer system 102 further comprises a network interface 116 coupled to the processor 104. The network interface 116 may take the form of modems, modem banks, Ethernet cards, Universal Serial Bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, or other network interfaces. In conjunction with execution of the communication application 110 by the processor 104, the network interface 116 enables initiation and maintenance of a remote conferencing session between the computer system 102 and a communication endpoint.

In accordance with at least some embodiments, execution of the media pipeline module 112 (e.g., by the processor 104) provides various media pipeline features for use with a conferencing session. As shown, the features may comprise a “participant control” feature, a “negotiate parameters” feature, a “media stream activity control” feature, an “audio stream combination” feature, and an “XML configuration” feature.

The participant control feature enables participants to be added or dropped without stopping the media pipeline. In at least some embodiments, the participant control feature is accomplished by building the media pipeline based on the assumption that there are a maximum number of participants for a conferencing session. Certain pipeline tasks are enabled for the maximum number of participants, while other pipeline tasks are idle until an active participant arrives. For example, a video source task, a video decode task, and an AEC task may be continuously enabled for all participants (active and inactive). Meanwhile, a network sender task and a network receiver task are idle for inactive participants and are enabled for active participants. By means of the participant control feature, there is no interruption to a conferencing session when participants are added or dropped.

The negotiate parameters feature operates to reduce conference set-up time. Before the start of a conferencing session, the negotiate parameters feature enables participating clients to exchange parameters such as video codecs, Internet Protocol (IP) addresses, and port information. Such parameters may be used to set a video de-compressor and network components to receive and send media during a conferencing session. The negotiate parameters feature enables tuning of parameters such as video resolution and codec parameters based on system and network resource availability. For example, if the communication application 110 is implemented on a computer system determined to have a low system bandwidth and/or a low network bandwidth, the negotiate parameters feature may select a lower camera resolution and/or may select a less processor-intensive codec.

The media stream activity control feature enables media streams to be muted or unmuted without stopping the media pipeline. In at least some embodiments, the media stream activity control feature is accomplished by shutting one or more selected media streams and inserting a “zero” media stream on the network for each selected media stream. The media stream activity control feature also may display an overlay image (e.g., a muted audio icon) on a conferencing window (e.g., a video window) or user interface window. In some embodiments, the media stream activity control feature operates based on user input. Additionally or alternatively, the media stream activity control feature operates based on a system bandwidth evaluation. The system bandwidth evaluation determines, for example, the available networking and processing bandwidth over time. If the networking or processing bandwidth becomes less than a threshold value, the media stream activity control feature may stop or prevent (e.g., by muting) one or more media streams at least temporarily. Subsequently, if the networking or processing bandwidth becomes more than the threshold value, the media stream activity control feature may start or re-start (e.g., by unmuting) one or more media streams. As used herein, muting and unmuting may be applied selectively to audio data, video data, or both.

The audio stream combination feature enables media streams to be combined to provide synchronization and/or AEC. In at least some embodiments, the audio stream combination feature operates in conjunction with the participant control feature to provide audio to an audio mixer component. For each active participant in a conferencing session, the audio stream combination feature is able to provide corresponding audio packets to the audio mixer component. For each inactive participant in a conferencing session, the audio stream combination feature provides empty audio packets to the audio mixer component.

In at least some embodiments, the audio stream combination feature is associated with an audio premix component that detects audio flow or a lack thereof for each participant of a conferencing session (both active and inactive participants). In response, the audio premix component forwards audio flow packets or empty audio packets to the audio mixer component.

The XML configuration feature enables flexible configuration of a media pipeline without recoding. As an example, Nizza software enables media pipeline components to be abstracted as tasks that are connected together. For each conferencing session, a set of audio devices, video devices, codecs and network components are implemented based on parameters selected by a user/administrator of the computer system 102. In other words, one of a plurality of media pipeline profiles is matched to the selected parameters. Once a suitable media pipeline profile is determined, components are initialized based on an order specified in a graph XML file. The graph XML file enables the media pipeline to be changed as needed by editing the XML description of the media pipeline (e.g., using a text editor).

In accordance with at least some embodiments, the communication application 110 establishes a peer-to-peer conferencing session between the computer system 102 and a communication endpoint based on “gateway remoting.” As used herein, “gateway remoting” refers to a technique of indirectly populating a contact list of potential conference clients for the communication application 110 and maintaining presence information for these potential conference clients using predetermined contact list and presence information maintained by at least one gateway server.

In order to access a contact list and presence information maintained by a given gateway server, a user at the computer system 102 often logs into the communication service provided by the given gateway server. Although the user could log into each gateway server communication service separately, some embodiments of the communication application 110 enable management of the login process for all gateway service accounts associated with the user of the computer system 102. For example, when a user successfully logs into the communication application 110, all gateway server accounts associated with the user are automatically activated (e.g., by completing a login process for each gateway server account). Additionally or alternatively, contact list information and presence information may be entered manually by via a local gateway connection.

To initiate a remote conferencing session, a user at the computer system 102 selects a conference client from the populated contact list of the communication application 110. The communication application 110 then causes an initial request to be sent to the selected conference client via an appropriate gateway server communication service provided by at least one gateway server. In some cases, there may be more than one appropriate gateway server communication service since the user of the computer system 102 and the selected conference client may be logged into multiple gateway server accounts at the same time. Regardless of the number of appropriate gateway server communication services, the computer system 102 does not yet have direct access to the communication endpoint associated with the selected conference client. After indirectly exchanging connection information (e.g., IP addresses and user names associated with the communication application 110) via a gateway server communication service (e.g., Gmail®, Jabber®, and Office Communicator®), the computer system 102 and the appropriate communication endpoint are able to establish a peer-to-peer conferencing session without further reliance on a gateway server or gateway server communication service. For more information regarding gateway remoting, reference may be had to U.S. application Ser. No. 12/551,273, filed Aug. 31, 2009, and entitled “COMMUNICATION APPLICATION,” which is hereby incorporated herein by reference.

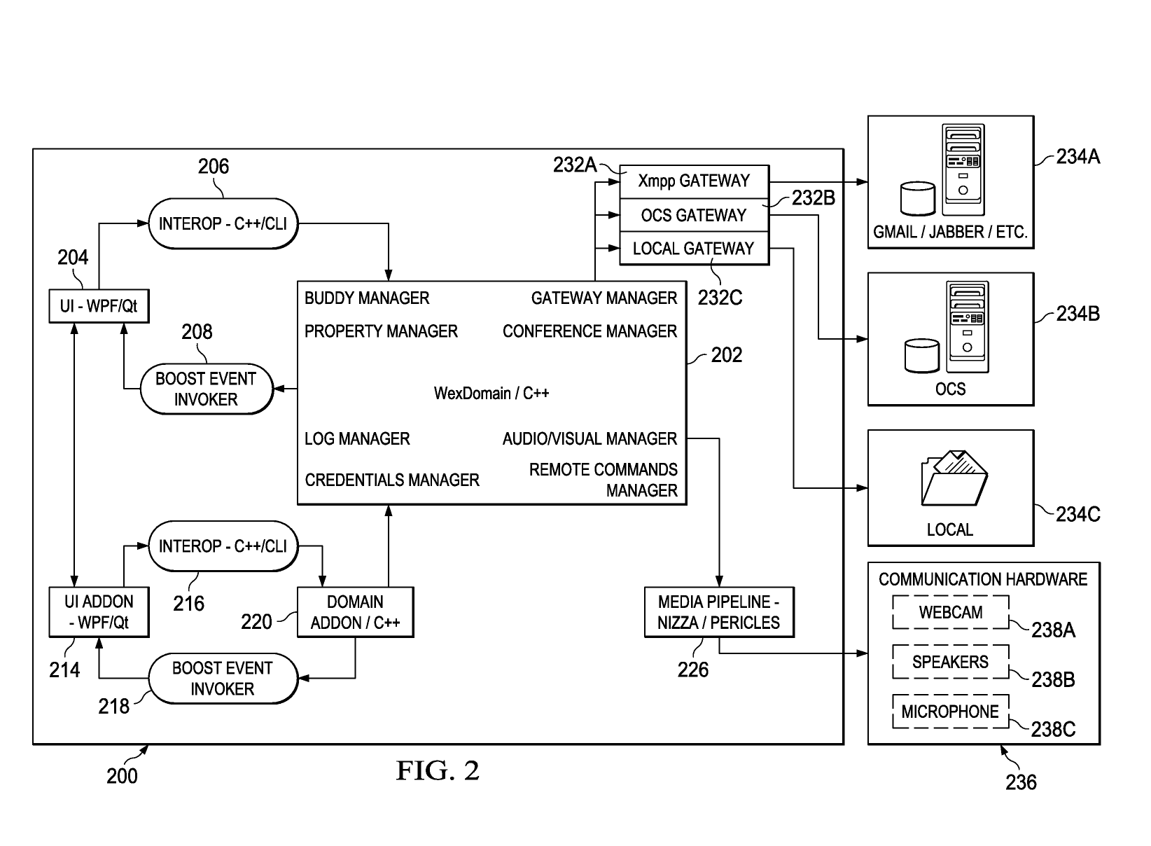

FIG. 2 illustrates various software components of a communication application 200 in accordance with an embodiment of the disclosure. The communication application 200 may correspond, for example, to either of the communication applications 110 and 142 of FIG. 1. As shown, the communication application 200 comprises a management module 202 that supports various management functions of the communication application 200. As shown, the management module 202 supports a “Buddy Manager,” a “Property Manager,” a “Log Manager,” a “Credentials Manager,” a “Gateway Manager,” a “Conference Manager,” an “Audio/Video (NV) Manager,” and a “Remote Command Manager.”

The Buddy Manager of the management module 202 maintains a contact list for the communication application 200. The Property Manager of the management module 202 enables administrative modification of various internal properties of the communication application 200 such as communication bandwidth or other properties. The Gateway Manager of the management module 202 provides an interface for the communication application 200 to communicate with gateway servers 254A-254C. As shown, there may be individual interfaces 232A-232C corresponding to different gateway servers 254A-254C since each gateway server may implement a different protocol. Examples of the interfaces 232A-232C include, but are not limited to, an XMPP interface, an OCS interface, and a local interface.

Meanwhile, the Conference Manager of the management module 202 handles communication session features such as session initiation, time-outs, or other features. The Log Manager of the management module 202 is a debug feature for the communication application. The Credentials Manager of the management module 202 handles login information (e.g., username, password) related to the gateway servers 254A-254C so that an automated login process to the gateway servers 254A-254C is provided by the communication application 200. The NV Manager of the management module 202 sets up an A/V pipeline to support the communication session. The Remote Commands Manager of the management module 202 provides remoting commands that enable the communication endpoint (e.g., the computer system 102) that implements the communication application 200 to send information to and receive information from a remote computer.

As shown, the management module 202 interacts with various other software modules. In at least some embodiments, the management module 202 sends information to and receives information from a user interface (UI) module 204. The UI module 204 may be based on, for example, Windows Presentation Foundation (WPF) or “Qt” software. In the embodiment of FIG. 2, the management module 202 sends information to the UI module 204 using a “boost” event invoker 208. As used herein, “boost” refers to a set of C++ libraries that can be used in code. On the other hand, the UI module 204 sends information to the management module 202 using a C++ interop (e.g., a Common Language Infrastructure (CLI) interop). To carry out the communication session, the management module 202 interacts with a media pipeline module 226. In at least some embodiments, the media pipeline module 226 corresponds to the media pipeline module 112 of FIG. 1. In operation, the media pipeline module 226 discovers, configures (e.g., codec parameters), and sends information to or receives information from communication hardware 236. Examples of communication hardware 236, include but are not limited to, web-cams 238A, speakers 238B and microphones 238C. The media pipeline module 226 also provides some or all of the features described for the media pipeline module 112 of FIG. 1 (e.g., the “participant control” feature, the “negotiate parameters” feature, the “media stream activity control” feature, the “audio stream combination” feature, and the “XML configuration” feature).

In the embodiment of FIG. 2, the UI module 204 and the management module 202 selectively interact with a UI add-on module 214 and a domain add-on module 220. In accordance with at least some embodiments, the “add-on” modules (214 and 220) extend the features of the communication application 200 for remote use without changing the core code. As an example, the add-on modules 214 and 220 may correspond to a “desktop sharing” feature that provides the functionality of the communication application 200 at a remote computer. More specifically, the UI add-on module 214 provides some or all of the functions of the UI module 204 for use by a remote computer. Meanwhile, the domain add-on module 220 provides some or all of the functions of the management module 202 for use by a remote computer.

Each of the communication applications described herein (e.g., communication applications 110, 142, 200) may correspond to an application that is stored on a computer-readable medium for execution by a processor. When executed by a processor, a communication application causes a processor to provide a media pipeline for a conferencing session and to selectively change participants during a conferencing session without restarting the media pipeline. A communication application, when executed, may further cause a processor to provide an interface that enables said participants to negotiate media pipeline parameters before the conferencing session begins. The media pipeline parameters may correspond to video codecs, IP addresses and/or port information. A communication application, when executed, may further cause a processor to selectively change media stream activity during the conferencing session based on a system bandwidth evaluation. A communication application, when executed, may further cause a processor to combine audio streams during a conferencing session to maintain synchronization and AEC for the audio streams. A communication application, when executed, may further cause a processor to provide an interface to configure the media pipeline based on Extensible Markup Language (XML).

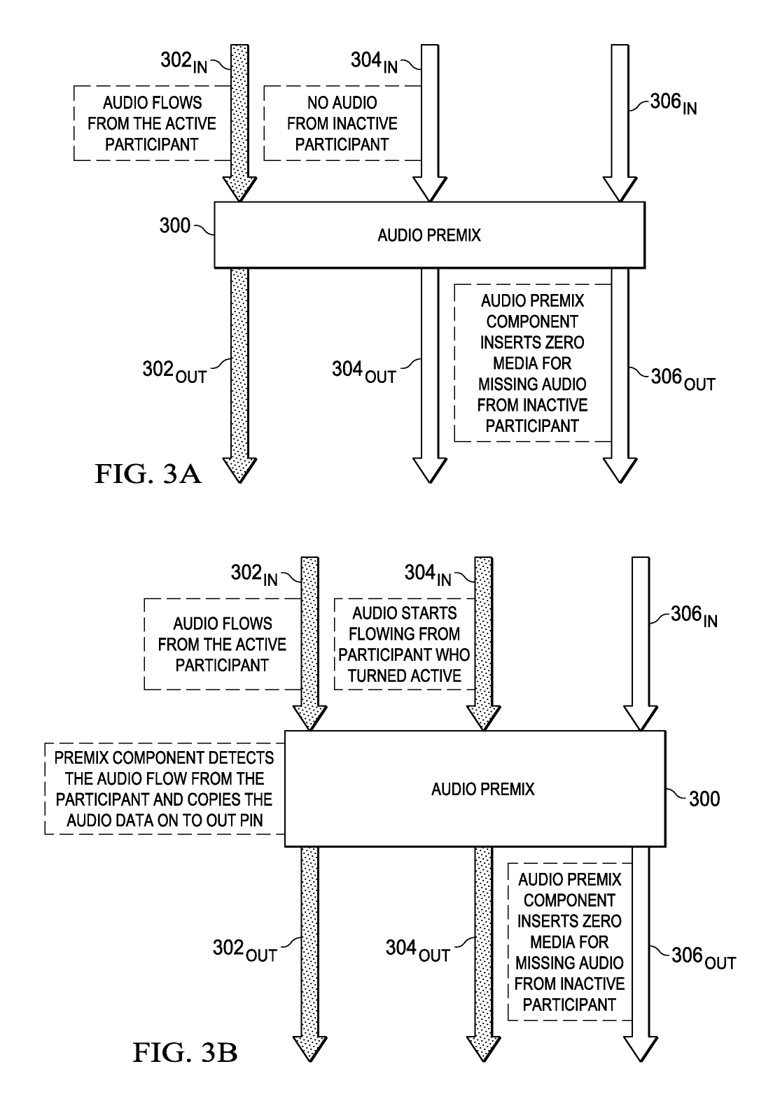

FIGS. 3A and 3B illustrate operation of an audio premix component 300 in accordance with an embodiment of the disclosure. The audio premix component 300 enables operations of the audio combination feature of the media pipeline module 112 mentioned previously. In FIG. 3A, the audio premix component 300 receives an audio flow from an active participant (shown as arrow 302_{IN}) and no audio flow from inactive participants (shown as arrows 304_{IN} and 306_{IN}). In response, the audio premix component 300 operates to output the audio flow from the active participant (shown as arrow 302_{OUT}) and to output empty audio packets (“zero” media) for the inactive participants (shown as arrows 304_{OUT} and 306_{OUT}). In FIG. 3B, a participant associated with the arrow 304_{IN} switches from an inactive state to an active state. Thus, the audio premix component 300 receives an audio flow from two active participants (shown as arrows 302_{IN} and 304_{IN}) and no audio flow from an inactive participant (shown as arrow 306_{IN}). In response, the audio premix component 300 operates to output the audio flow from the active participants (shown as arrows 302_{OUT} and 304_{OUT}) and to output empty audio packets (“zero” media) for the inactive participant (shown as arrow 306_{OUT}).

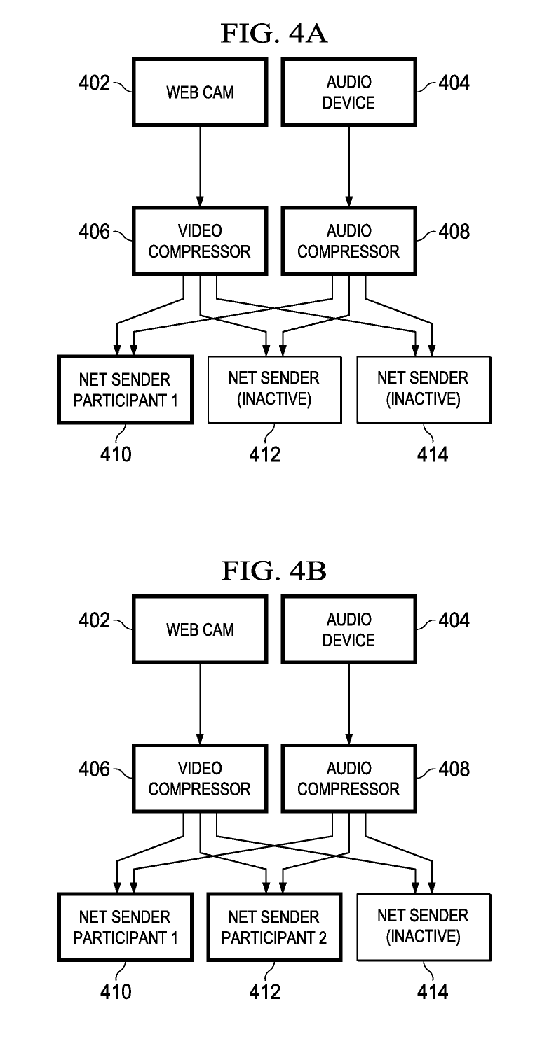

FIGS. 4A and 4B illustrate audio/video transmission in accordance with an embodiment of the disclosure. The blocks of FIGS. 4A and 4B represent software modules of a media pipeline. In FIG. 4A, a web cam block 402 provides video data to a video compressor block 406 and an audio device block 404 (e.g., receiving audio from a microphone) provides audio data to an audio compressor block 408. The video compressor block 406 and the audio compressor block 408 respectively output compressed video and compressed audio to network sender blocks 410, 412 and 414, even if some of the network sender blocks are inactive. For example, in FIG. 4A, the network sender block 410 is active, while the network sender blocks 412 and 414 are inactive. In FIG. 4B, the network sender blocks 410 and 412 are active, while the network sender blocks 414 is inactive. In other words, FIGS. 4A and 4B show that the number of active participants in a conferencing session may change, but the number of network sender blocks in the media pipeline does not change. In this manner, participant changes during a conferencing session do not interrupt the media pipeline.

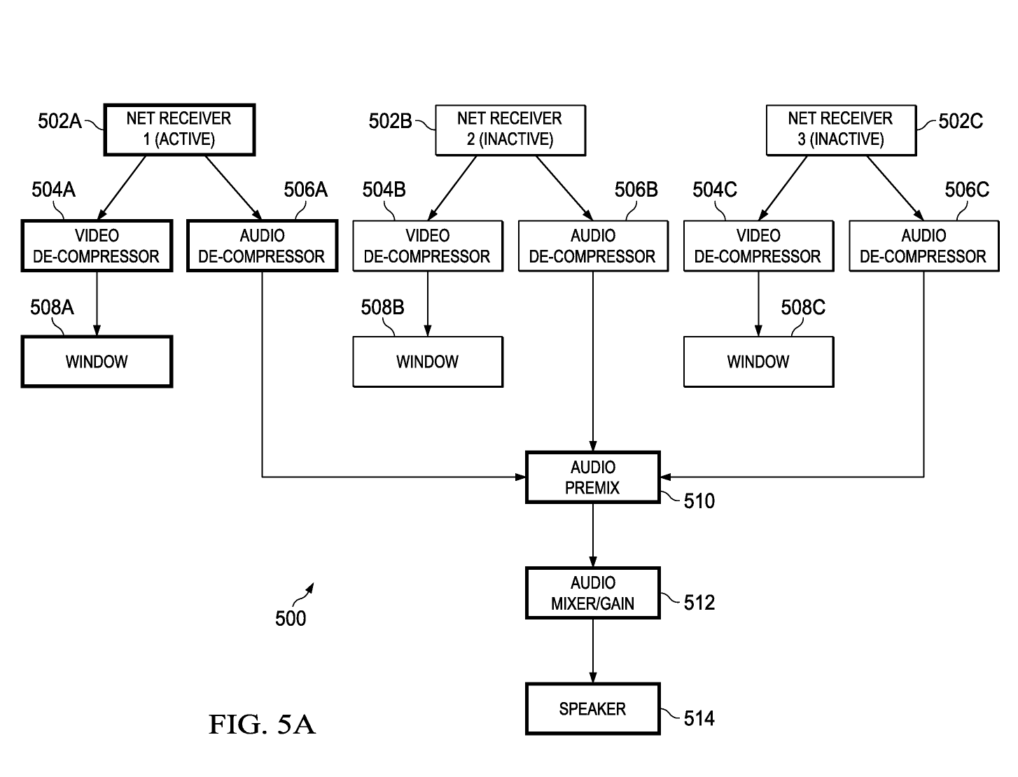

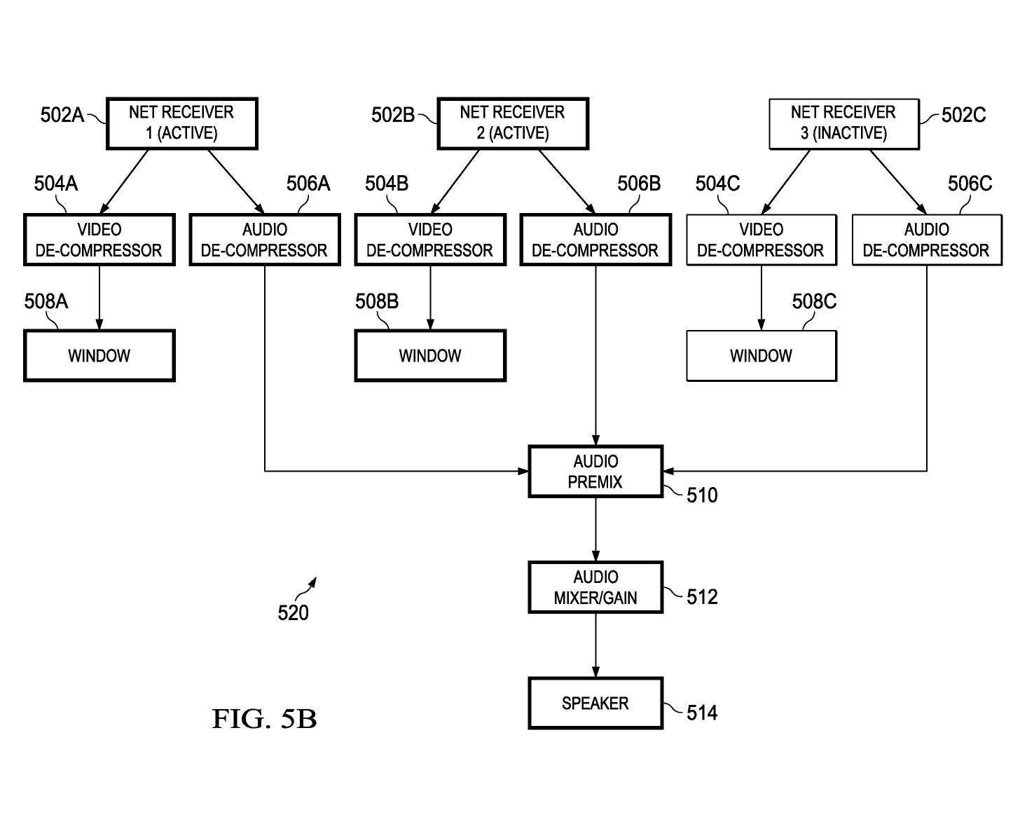

FIGS. 5A and 5B illustrate audio/video reception in accordance with an embodiment of the disclosure. The blocks of FIGS. 5A and 5B represent software modules of a media pipeline. In FIG. 5A, a plurality of network receiver blocks 502A-502C receive audio/video data from a network. Each of the network receiver blocks 502A-502C couple to a corresponding video de-compressor block 504A-504C and a corresponding audio de-compressor block 506A-506C. Meanwhile, each video de-compressor block 504A-504C couples to a corresponding window block 508A-508C. The window blocks 508A-508C operate to display video data from the video de-compressors 504A-504C. Meanwhile, an audio premix block 510 receives the output from the audio de-compressors 506A-506C. The audio premix block 510 synchronizes the received audio data. For active participants, the audio premix block 510 forwards the received audio flow to an audio mixer/gain block 512. For inactive participants, the audio premix block 510 forwards “zero” data or empty audio packets to the audio mixer/gain block 512. The audio mixer/gain block 512 adjusts the received audio based on predetermined mixer/gain parameters. AEC also may be performed on the received audio after the mixer/gain function. As shown, the output of the audio mixer/gain block 512 is provided to a speaker block 514.

In FIG. 5A, the input to network receiver block 502A is for an active participant, while the input to network receiver blocks 502B and 502C is for inactive participants. In contrast, FIG. 5B shows the input to network receiver blocks 502A and 502B is for active participants, while the input to network receiver block 502C is for an inactive participant. In other words, FIGS. 5A and 5B show that the number of active participants in a conferencing session may change, but the number of network receiver blocks (e.g., network receiver blocks 502A-502C) and related media pipeline blocks (e.g., video de-compressor blocks 504A-504C, audio de-compressor blocks 506A-506C, and window blocks 508A-508C) do not change. In this manner, participant changes during a conferencing session do not interrupt the media pipeline.

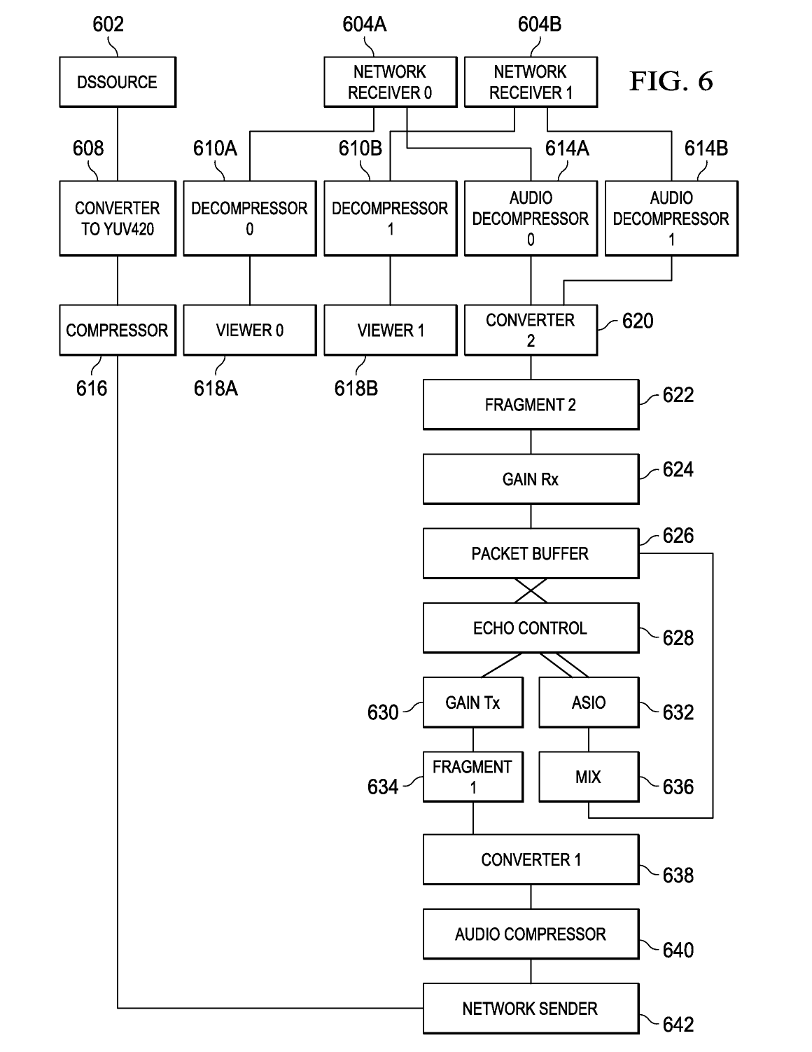

FIG. 6 illustrates components of a media pipeline 600 in accordance with am embodiment of the disclosure. The media pipeline 600 is abstracted by software (e.g., Nizza software) as tasks that are connected together. As shown, the media pipeline 600 comprises a “DS Source” block 602 connected to a converter block 608. The DS Source block 602 represents a digital media source (e.g., a web-cam) and the converter block 608 converts the digital media (e.g., video data) from the digital media source 602 from one format to another. As an example, the converter block 608 may change the color space of video data from a RGB pixel format to YUV format. The converted video data from the converter block 608 is provided to a compressor block 616 to compress the converted video data. The converted/compressed video data (CCVD) is then sent to a network sender block 642, which prepares the CCVD for transmission via a network. The network sender block 642 also receives converted/compressed audio data (CCAD) for transmission via a network. The audio data stream initiates at the Audio Stream Input/Output (ASIO) block 632, which handles data received from one or more microphones. The ASIO block 632 forwards microphone data to mix block 636, which adjusts the audio gain. The output of the mix block 636 is received by packet buffer 626 to control the rate of data (providing a latency guarantee). An echo control block 628 receives the output of the packet buffer 626 and performs echo cancellation on the audio data. The output of the echo control block 628 is then provided to transmitter gain block 630 to selectively adjust the audio transmission gain. The audio data from the transmitter gain block 630 becomes CCAD by the operation of a fragment 1 block 634, a converter 1 block 638, and an audio compressor block 640. As previously mentioned, the CCVD and CCAD are received by network sender block 642 for transmission via a network.

In FIG. 6, two participants receive the CCVD and CCAD from the network sender block 642. Alternatively, there could be more or less than two participants that receive the CCVD and CCAD. With two participants, network receiver blocks 604A and 604B receive the CCVD and CCAD from the network. The CCVD is passed to decompressor blocks 610A and 610B, which provides decompressed video for presentation by viewer blocks 618A and 618B. Meanwhile, the CCAD received by the network receiver blocks 604A and 604B is provided to audio decompressors 614A and 614B. The decompressed audio from decompressors 614A and 614B is converted to another format by converter 2 block 620, then is fragmented by fragment 2 block 622. The output of the converter 2 block 620 is provided to receiver gain block 624 to selectively adjust the receiver gain of the audio data. The output of the receiver gain block 624 is handled by packet buffer 626 to control the rate of data (providing a latency guarantee) related to the ASIO block 632. The echo control block 628 receives audio data from the packet buffer 626 and provides echo cancellation. The output of the echo control block 628 is provided to the ASIO block 632 for presentation by speakers (e.g., left and right speakers).

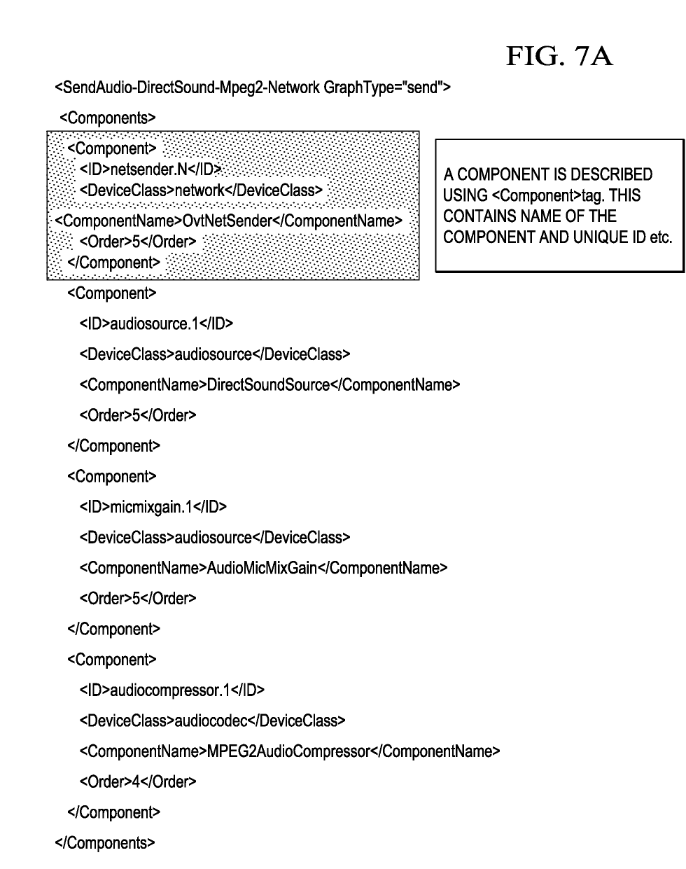

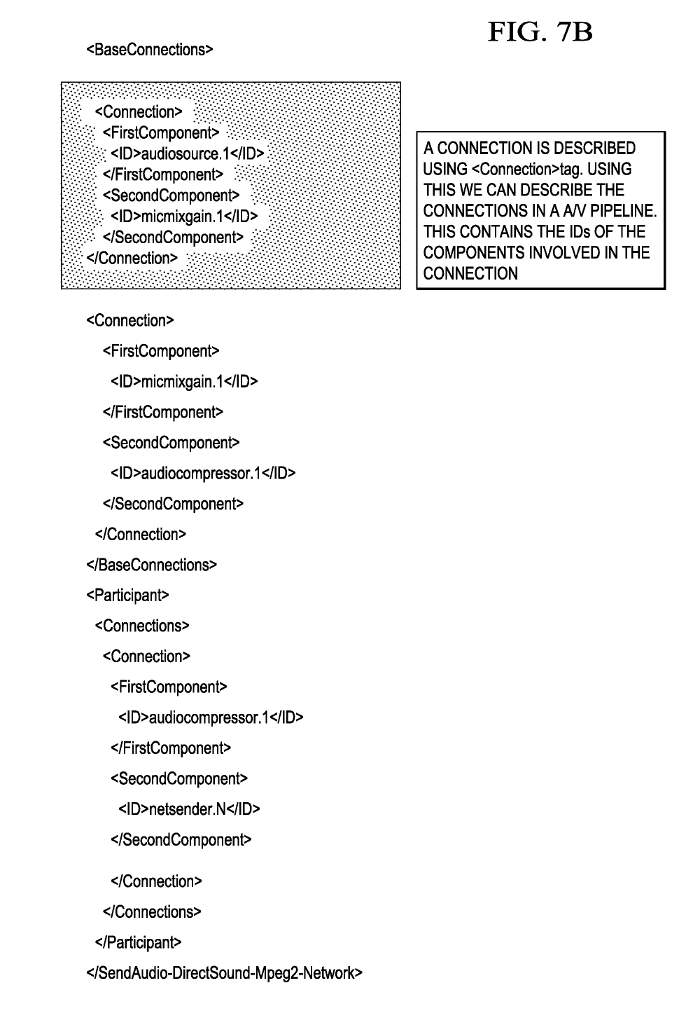

FIGS. 7A-7B illustrate configuration of a media pipeline based on Extensible Markup Language (XML) in accordance with an embodiment of the disclosure. More specifically, FIGS. 7A-7B illustrate audio components of a media pipeline. As shown, components of a media pipeline may be represented using component names, component identifiers (IDs), component class information, and order information. FIGS. 7A-7B also provide connection information between components of a media pipeline. In other words, FIGS. 7A-7B represent a textual graph of a media pipeline using XML. The media pipeline described in FIGS. 7A-7B may be changed as needed by editing the XML description of the media pipeline (e.g., using a text editor). In accordance with at least some embodiments, a plurality of different XML configurations may be stored, where each XML configuration corresponds to a distinct instantiation of a media pipeline. In other words, different media pipelines may vary with respect to configuration and capability. As an example, different XML configurations may correspond to a “test audio” media pipeline, a “test video” media pipeline, a “parameter negotiation” media pipeline, a “settings panel” media pipeline, and so on. As needed, such XML configurations may be selected and updated for media pipeline instantiation.

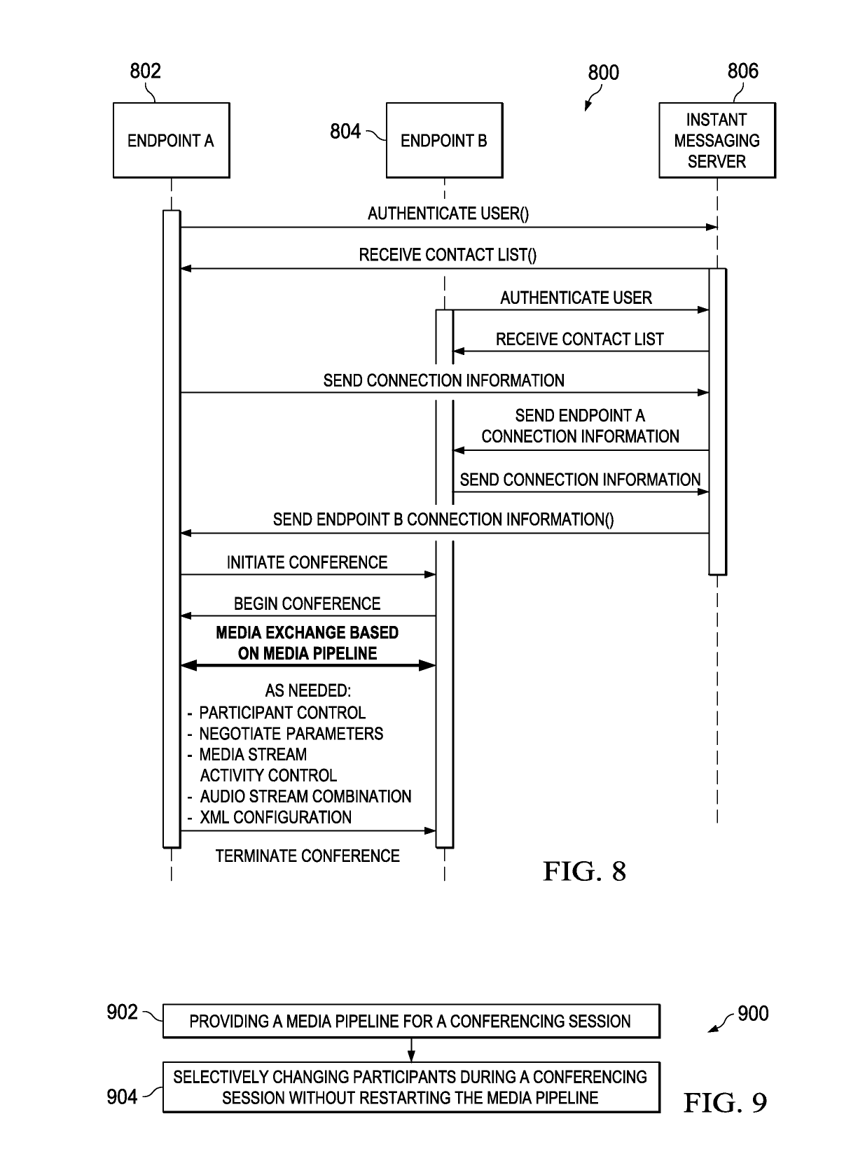

FIG. 8 illustrates a conferencing technique 800 in accordance with an embodiment of the disclosure. In FIG. 8, the steps begin chronologically at the top (nearest the blocks representing endpoints 802, 804 and instant messaging (IM) server 806) and proceed downward. As shown, the IM server 806 authenticates a user of the endpoint A 802. In response, the endpoint A 802 receives a contact list from the IM server 806. Next, the IM server 806 authenticates a user of the endpoint B 804. In response, the endpoint B 804 receives a contact list from the IM server 806. Based on the contact list from the IM server 806, endpoint A 802 sends connection information to the IM server 806, which forwards endpoint A connection information to the endpoint B 804. Similarly, endpoint B 804 sends connection information to the IM server 806, which forwards endpoint B connection information to the endpoint A 802. In other words, the endpoint A 802 and the endpoint B 804 exchange primary connection information via the IM server 806. Subsequently, the endpoint A 802 is able to initiate a conference with endpoint B 804 based on a media pipeline having various features such as the participant control feature, the negotiate parameters feature, the media stream activity control feature, the audio stream combination feature, and/or the XML configuration feature described herein. After initiation of a conferencing session (e.g., a user of endpoint B 804 accepts a request to participate in a remote conferencing session with a user of endpoint A 802), a media exchange occurs. Eventually, the conference terminates.

FIG. 9 illustrates a method 900 in accordance with embodiments of the disclosure. As shown, the method 900 comprises providing a media pipeline for a conferencing session (block 902). The method 900 further comprises selectively changing participants during a conferencing session without restarting the media pipeline (block 904).

The method 900 may comprise additional steps that are added individually or in combination. As an example, the method 900 may additionally comprise providing an interface that enables said participants to negotiate media pipeline parameters before the conferencing session begins. The method 900 may additionally comprise selectively changing media stream activity during the conferencing session based on a system bandwidth evaluation. The method 900 may additionally comprise, if a system bandwidth evaluation indicates that system bandwidth is less than a threshold amount, stopping at least one media stream during the conferencing session. The method 900 may additionally comprise combining audio streams during a conferencing session to maintain synchronization and acoustic echo cancellation (AEC) for the audio streams. The method 900 may additionally comprise providing an interface to configure the media pipeline based on Extensible Markup Language (XML). In at least some embodiments, the method 900 comprises storing a plurality of updatable XML configurations, each XML configuration corresponding to a distinct instantiation of a media pipeline for use by the communication application.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a network interface coupled to the processor; and
a system memory coupled to the processor, the system memory storing a communication application having a media pipeline module,
wherein the media pipeline module, when executed, provides a media pipeline for a conferencing session of the communication application,
wherein the media pipeline module enables dynamic changes to participants during a conferencing session without restarting the media pipeline.

2. The computer system of claim 1 wherein the media pipeline module enables said participants to negotiate media pipeline parameters dynamically.

3. The computer system of claim 2 wherein said media pipeline parameters comprise video codecs, Internet Protocol (IP) addresses, and port information.

4. The computer system of claim 1 wherein the media pipeline module enables dynamic changes to media stream activity during the conferencing session based on a system bandwidth evaluation.

5. The computer system of claim 1 wherein the media pipeline module combines audio streams during a conferencing session to maintain synchronization for the audio streams.

6. The computer system of claim 1 wherein the media pipeline module combines audio streams during a conferencing session to provide acoustic echo cancellation (AEC) for the audio streams.

7. The computer system of claim 1 wherein the media pipeline module enables configuration of the media pipeline based on Extensible Markup Language (XML).

8. The computer system of claim 7 wherein a plurality of updatable XML configurations are stored, each XML configuration corresponding to a distinct instantiation of a media pipeline.

9. A computer-readable storage medium storing a communication application that, when executed, causes a processor to:
provide a media pipeline for a conferencing session; and
selectively change participants during a conferencing session without restarting the media pipeline.

10. The computer-readable storage medium of claim 9 wherein the communication application, when executed, causes the processor to provide an interface that enables said participants to negotiate media pipeline parameters before the conferencing session begins.

11. The computer-readable storage medium of claim 9 wherein the media pipeline parameters comprise video codecs, Internet Protocol (IP) addresses, and port information.

12. The computer-readable storage medium of claim 9 wherein the communication application, when executed, causes the processor to selectively change media stream activity during the conferencing session based on a system bandwidth evaluation.

13. The computer-readable storage medium of claim 9 wherein the communication application, when executed, causes the processor to combine audio streams during a conferencing session to maintain synchronization and acoustic echo cancellation (AEC) for the audio streams.

14. The computer-readable storage medium of claim 9 wherein the communication application, when executed, causes the processor to provide an interface to configure the media pipeline based on Extensible Markup Language (XML).

15. A method for a communication application, comprising:
providing a media pipeline for a conferencing session; and
selectively changing participants during a conferencing session without restarting the media pipeline.

16. The method of claim 15 further comprising providing an interface that enables said participants to negotiate media pipeline before the conferencing session begins.

17. The method of claim 15 further comprising selectively changing media stream activity during the conferencing session based on a system bandwidth evaluation.

18. The method of claim 17 wherein, if a system bandwidth evaluation indicates that system bandwidth is less than a threshold amount, stopping at least one media stream during the conferencing session.

19. The method of claim 15 further comprising combining audio streams during a conferencing session to maintain synchronization and acoustic echo cancellation (AEC) for the audio streams.

20. The method of claim 15 further comprising providing an interface to configure the media pipeline based on Extensible Markup Language (XML).
